(19) United States
(12) Patent Application Publication
(10) Pub. No.: US 2025/0046204 A1
(43) Pub. Date: Feb. 6, 2025

(54) METHOD FOR SUPPORTING SELF-DIRECTED LEARNING BY STUDENT

(71) Applicant: Mi Young Kim, Incheon (KR)

(72) Inventor: Mi Young Kim, Incheon (KR)

(21) Appl. No.: 18/793,798

(22) Filed: Aug. 3, 2024

(30) Foreign Application Priority Data
Aug. 3, 2023 (KR) 10-2023-0101795
Aug. 3, 2023 (KR) 10-2023-0101800

(51) Int. Cl. G09B 7/02; G06F 40/289; G06V 30/10; G09B 3/04

(52) U.S. Cl. CPC G09B 7/02; G06F 40/289; G09B 3/04; G06V 30/10

(57) ABSTRACT

Disclosed is a method for supporting self-directed learning by students by helping students who have studied with or learned from textbooks, workbooks, or storybooks to outline and organize what they have studied or learned on their own, to thereby improve their learning efficiency with respect to the contents of the textbooks, workbooks, or storybooks. Here, the content of the textbook is displayed or listed in subdivisions as a plurality of main contents (table-of-contents, index, heading, etc.) and of sub-contents, wherein the sub-content is a sub-section of the main contents, and the sub-contents subdivide the content of the already learned or studied textbook and guides the students, by individually subdividing the content of the textbook listed or included in the sub-units according to its subject matter and making suggestions or hinting the students thereof. Also disclosed are a worksheet and mind map sheet for use in implementing the method.

### RELATED APPLICATIONS

The present application claims the benefit of priority to Korea Patent Application No. 1020230101795 (filed 2023 Aug. 3), which is now Korea Patent No. 1026210700000 (issued 2023 Dec. 29), and the entire contents of each of which are incorporated by reference.

### BACKGROUND

### 1. Field of the Invention

The present invention relates to a method for assisting students' self-directed learning, and relates particularly to a method for supporting self-directed learning by students by assisting students who have studied from textbooks, workbooks, and storybooks to outline, organize, or summarize what they have learned on their own, to thereby improve their learning efficiency with respect to the contents of the textbooks, workbooks, and storybooks.

### 2. Description of Related Art

Patent Document 0001 discloses a triple-N study set, which includes Hangul (i.e., the Korean alphabet, language) and mathematics linked learning aids and materials, and a Hangul and mathematics linked learning method using the set. The Document proposes a technique related to the triple-N study set, which includes aids and materials that enables simultaneous learning(s) of Hangul and mathematics, to maximize overall learning curve by enabling a child learner to develop creativity and cognitive and problem solving abilities. Here, the child learner efficiently learns Hangul and mathematics in a short period of time through: a 50-minute, triple-N Hangul course package, which includes a letter learning section, an associated picture cards section, a game learning section, and a writing materials section; and a 60-minute, triple-N mathematics course package, which includes a concrete object learning section, an image learning section, and a problem solving section. And afterward, the child learner learns Hangul and mathematics simultaneously via creative activities through a triple-N final stage course package, which utilizes (the) triple-N aids and materials.

Patent Document 0002 discloses techniques related to Korean language teaching materials for preschool children. The Hangul (Korean language) textbook for children includes a single-letter/character or syllabic block association learning unit in which a plurality of the single letters are individually matched with associative images, and an extended letter observation learning unit in which an extended single-letter/character in which a representative final consonant is combined with the single letters provided in the single-letter association learning unit and matched with an observation image as to a shape or form of a face formed during pronunciation of the representative final consonant, and a consonant-vowel separated learning unit in which consonants and vowels are separated with respect to the single-letter and the extended single-letter and an object image suggestive of a form of each separated consonant are matched, and provides a technique wherein the single letters are composed of only basic consonants and basic vowels and does not have final consonants.

Patent Document 0003 discloses a reading coaching system using artificial-intelligence-based big data analysis. More specifically, in periods such as childhood and adolescence when the best intellectual growth can be achieved through reading, a customized reading program suitable for students' reading ability can be presented based on objectively analyzed data. Presented as well, is a reading coaching system using artificial intelligence-based big data analysis that makes possible correct reading habits, improvement of writing skills, and acquisition of various background knowledge, etc., through coaching process of a professional reading coach.

Patent Document 0004 discloses techniques related to customized learning games and learning materials logs to improve creativity. More specifically, in its method of providing learning materials for children, when a plurality of education books for children's education exist and at least one specific education book is selected from the plurality of education books, a plurality of evaluation categories required to perform evaluation of the education books include at least a first evaluation category and a second evaluation category, and when evaluation items corresponding to the first evaluation category include at least an 1-1 evaluation item and a 1-2 evaluation item, and when evaluation items corresponding to the second evaluation category include and at least a 2-1 evaluation item and a 2-2 evaluation item: (i) for a particular book among the education books, a first evaluation score corresponding to the first evaluation category based on the score of the 1-1 evaluation item and the score of the 1-2 evaluation item is calculated; (ii) for a specific book among the education books, a second evaluation score corresponding to the second evaluation category based on the score of the 2-1 evaluation item and the score of the 2-2 evaluation item is calculated; and of evaluation levels in a preset range, a first evaluation level corresponding to the first evaluation score and a second evaluation level corresponding to the second evaluation score are each derived, and a specific evaluation-table image expressing the first evaluation level and the second evaluation level is generated, and thereafter, a learning method is proposed wherein a certain area of a specific learning material using a specific education book includes the specific evaluation table image for the specific education book.

### RELATED ART DOCUMENTS

(Patent Document 0001) KR 10-2535507 (issued 2023 May 18)

(Patent Document 0002) KR 10-1537802 (issued 2015 Jul. 13)

(Patent Document 0003) KR 10-2386688 (issued 2022 Apr. 11)

(Patent Document 0004) KR 10-2355026 (issued 2022 Jan. 19)

### BRIEF SUMMARY

### Technical Problems

An object of the present invention is to provide a method for supporting a self-directed learning that enables students who have studied or learned from a textbook, etc. to summarize the content learned on their own, to thereby improve their learning efficiency with respect to the content of the textbook.

Other objects and advantages of the present invention will be understood from the descriptions below and will be more clearly understood by the embodiments and examples of the present invention. In addition, it will be readily apparent that the objects and advantages of the present invention may be realized by the means, methods, and combinations thereof, as described in the claims.

### Solution to Problems

To achieve the objects, the method for supporting a self-directed learning according to the present invention, a method for supporting self-directed learning by students to help student who has studied with textbooks, workbooks, or storybooks to outline and organize what was learned, to thereby improve learning efficiency with respect to contents of the textbooks, workbooks, or storybooks, wherein the contents of the textbook is arranged in divisions of main units and sub-units of the main units, or in subdivisions as a plurality of main contents and a plurality of sub-contents, where the sub-content is a sub-section of the main contents, the method comprising: a step of providing a worksheet so that a student who has studied with the textbook recalls and reviews the subject matter described in the sub-units, wherein the sub-contents or sub-table-of-contents items guides the student, by individually subdividing the contents of the textbook listed or included in the sub-units according to its subject matter and making suggestions or hinting the student thereof, and the worksheet includes blank spaces that allows the student to summarize and write down the subject matter corresponding to the sub-contents; and a step of providing a mind map sheet so that a student who has written a summary of the subject matter in the blank space of the worksheet may combine, aggregate and summarize a plurality of the subject matters described in the main units of the textbook, wherein a mind map sheet includes a vertical, central blank space for writing the main contents corresponding to the main unit, and a horizontal, side blank space located on a side of the central blank space so that the subject matter and the sub-content may be written and filled in together.

The method for supporting self-directed learning by students according an embodiment may further comprise: a step of a scanning unit (110) scanning the worksheet on which the student summarizes the subject matter of the textbook; a step of an OCR-recognizing unit (111) OCR-recognizing respective contents of a scanned copy of the worksheet and a scanned copy of the textbook, and converting the respective contents into digital text; a step of a textbook recognizing unit (120) extracting one or more keywords relating to the subject matter from a digital text copy of the textbook; a step of a worksheet recognizing unit (130) searching sub-contents of a digital text copy of the worksheet for a sub-content matching the keyword or keywords extracted by the textbook recognizing unit (120) and recognizing a location of the sub-content; a step of a grading unit (140) comparing whether a text within a blank space next to the sub-contents of the worksheet matches another keyword in the textbook, when the location of the sub-content in the worksheet that matches the keyword of the textbook is recognized; and a step of a sub-content reviewing unit (150) deleting the sub-content in the digital text copy of the worksheet and checking whether a text matching the sub-content is input by the student.

Here, the step of the textbook recognizing unit (120) extracting one or more keywords relating to the subject matter from the digital text copy of the textbook may comprises: a step of a paragraph beginning-point recognizing unit (121) recognizing a position of a first appearing word or first appearing syllable of the word of a text in the digital text copy of the textbook, and when the first appearing syllable of the text (or a target syllable) is located toward a right side of a first appearing syllable of a text located on a line immediately above or below the text, recognizing the first syllable of the word of the text (the target syllable) as a beginning point of a paragraph; a step of a paragraph ending-point recognizing unit (122) recognizing a period and blank spaces in the digital text copy of the textbook, and when there are three or more such spaces after the period in a sentence, recognizing the period in the sentence as an ending point of the paragraph; a step of a sentence recognition unit (123) recognizing one period as a beginning point of a sentence in the digital text copy of the textbook and another period, which is a/the first appearing period after the 1st period, as an ending point of the sentence, and then recognizing the text between the 1st period and the 2nd period as one sentence; a step of a phrase recognition unit (124) recognizing a comma and characters or term after the comma, and when the characters or term after the comma is one of a conjunction (part of speech), such as “by”, “as”, “then”, “and”, “so”, etc., text after the comma and the text before the comma are each recognized as a phrase; and a step of a postposition deleting unit (125) deleting a postposition (part of speech, or grammatical particles indicating relationship between a noun, pronoun or other elements in a sentence) characters or term in the copy of the digital text; and a step of a keyword extracting unit (126) extracting as a keyword or keywords in the text remaining in the copy of the digital text after the deleting step.

Here, the step of the worksheet recognizing unit (130) searching sub-content of the digital text copy of the worksheet for the sub-content matching the keyword or keywords extracted by the textbook recognizing unit (120) and recognizing the location of the sub-content may comprise: a step of a paragraph location matching unit recognizing a 1st keyword extracted from a 1st paragraph of the textbook recognized by the paragraph beginning-point recognition unit (121) and the paragraph ending-point recognition unit (122), and searching the digital text copy of the worksheet for a 1st sub-content matching the 1st keyword; a step of a sentence location matching unit recognizing a 2nd keyword extracted from a 1st sentence of the textbook recognized by the sentence recognition unit (123), and searching the digital text copy of the worksheet for a 2nd sub-content, which is a subsection of the 1st sub-content, matching the 2nd keyword; and a step of a phrase location matching unit recognizing a 3rd keyword from a 1st phrase of the textbook recognized by the phrase recognition unit (124), and searching the digital text copy of the worksheet for a 3rd sub-content, which is a subsection of the 2nd sub-content, matching the 3rd keyword.

Here, the step of the grading unit (140) comparing whether a text within the blank space next to the sub-contents of the worksheet matches another keyword in the textbook, when the location of the sub-content in the worksheet that matches the keyword of the textbook is recognized may comprises: a step of a corrective measure determining unit (141) comparing to see whether a 4th keyword, 5th keyword, and 6th keyword extracted from the first paragraph, first sentence, and first phrase match the text in the blank space next to the 1st sub-content, 2nd sub-content, and 3rd sub-content, respectively; and a step of a score calculation unit (142) calculating the number of matches between the fourth keyword, the fifth keyword, and the sixth keyword with the text in the blank space.

Here, the step of the sub-content reviewing unit (150) deleting the sub-content from the digital text copy of the worksheet and checking whether a text matching the sub-content is input by the student may comprise: a step of a 3rd sub-content reviewing unit (153) deleting the 3rd sub-content from the digital text copy of the worksheet and checking whether the text matching the 3rd sub-content is input by the student, when the 4th keyword, 5th keyword, and 6th keyword all match the text in the blank space; a step of a 2nd sub-content reviewing unit (152) deleting the 2nd sub-content from the digital text copy of the worksheet and checking whether the text matching the 2nd sub-content is input by the student, when the text matching the 3rd sub-content is input; and a step of 1st sub-content reviewing unit (151) deleting the 1st sub-content from the digital text copy of the worksheet and checking whether the text matching the 1st sub-content is input by the student, when the text matching the 2nd sub-content is input.

### Advantageous Effects

According to the method for supporting a self-directed learning of the present invention, which has above-described configuration, the learning efficiency with respect to the content of the textbook may be improved by enabling students who have learned from the textbook, etc. to summarize what they have learned on their own,

Other effects and advantages of the present invention may be understood by the description below, and will be more clearly understood by the embodiments and examples of the present invention. In addition, it will be readily apparent that the effects and advantages of the present invention may be realized by the means, methods and combinations thereof, as described in the claims.

### BRIEF DESCRIPTION OF THE DRAWINGS

FIG. 1 shows an illustrative diagram for describing the method for supporting self-directed learning, according to an embodiment of the present invention.

FIG. 2 shows a diagram of a content of a textbook, which has been scanned by the method for supporting self-directed learning, according to an embodiment of the present invention.

FIG. 3 shows a diagram of a content of a textbook, which has been scanned by the method for supporting self-directed learning, according to an embodiment of the present invention.

FIG. 4A shows an illustrative diagram for describing the method for supporting self-directed learning, according to an embodiment of the present invention.

FIG. 4B shows a diagram of a worksheet, which is provided by the method for supporting self-directed learning, according to an embodiment of the present invention.

FIG. 5A shows another illustrative diagram (in English) for describing the method for supporting self-directed learning, according to an embodiment of the present invention.

FIG. 5B shows another diagram of a worksheet (in English), which is provided by the method for supporting self-directed learning, according to an embodiment of the present invention.

FIG. 6 shows an illustrative diagram for explaining the method for supporting self-directed learning, according to an embodiment of the present invention.

FIG. 7-FIG. 9 show a diagram of a mind-map sheet, which is provided by the method for supporting self-directed learning, according to an embodiment of the present invention.

FIG. 10 shows a block diagram of components, which are used in implementing the method for supporting self-directed learning, according to an embodiment of the present invention.

FIG. 11-FIG. 16 show mathematics aids and materials, which are utilized in the method for supporting self-directed learning, according to an embodiment of the present invention.

FIG. 17 shows a diagram for describing the mind-map sheet, which is utilized in the method for supporting self-directed learning, according to an embodiment of the present invention.

FIG. 18-FIG. 28 show an illustrative diagram for describing a process performed by a number (arrangement) board in the method for supporting self-directed learning, according to an embodiment of the present invention.

FIG. 29 shows a diagram of a worksheet, which is provided by the method for supporting self-directed learning, according to an embodiment of the present invention.

FIG. 30 shows a block diagram of components, which are used in implementing the method for supporting self-directed learning, according to an embodiment of the present invention.

### DETAILED DESCRIPTION

The objects and effects of the present invention, and technical configurations for achieving them will be readily apparent when referring to the embodiments described in detail below along with the accompanying drawings. In describing the present invention, when it is determined that a detailed description of a known function or configuration may unnecessarily obscure the gist of the present invention, the detailed description will be omitted.

Terminology described below include terms that are defined in consideration of the functions in the present invention, and may vary depending on the intention or custom of the user or operator.

Further, the present invention is not limited to any of the embodiments set forth below, but may be configured or implemented in various forms that are different from each other. These embodiments are merely provided to better ensure that the disclosure of the present invention is complete and to more fully inform those skilled in the art, the scope of the invention—and that the present invention is defined by the breadth and scope of the claims. Therefore, this definition should be made based on the contents throughout the present disclosure.

Throughout the disclosure, when any part “includes” or “is provided with” any component or element, this does not mean that other components are excluded, but that other components may be further included, unless specifically stated to the contrary. Additionally, terms such as “. . . unit” used in the present disclosure refer to a unit that performs or processes at least one function or operation, and may be implemented as hardware, software, or a combination of hardware and software. Specifically, components referred to as “. . . unit” may be implemented through CPU, AP, graphics card, hard disk, SSD, monitor, etc. in a desktop computer, laptop computer, smartphone, or tablet.

Meanwhile, in an embodiment of the present invention, each component, functional block or means may be comprise one or more sub-components, and electrical, electronic, and mechanical functions that are performed by each component may be implemented with various known elements such as Circuit integrated into electronic circuits, integrated circuits, and ASICs (Application Specific Integrated Circuits). or mechanical elements, and each may be implemented separately, or as two or more integrated into one.

In addition, each block in the accompanying block diagrams and each step in the flow diagrams, or a combination thereof, may be executed by computer program instructions. These computer program instructions may be installed on a processor of a general-purpose computer, a special-purpose computer, a portable laptop computer, a network computer, a mobile device such as a smartphone, an online game service providing server, or other programmable data processing equipment, and accordingly, the instructions, which are executed through the processor of the computer device or other programmable data processing equipment, create a means of performing the functions described in each block of the block diagrams or each step of the flow diagrams described below.

These computer program instructions may also be stored in memory that is usable or available to a computer device or in computer-readable memory that may be directed to or supported by the computer device or other programmable data processing equipment to implement a function in a particular manner, and as such, it is also possible to produce a product, which contains instruction means that perform the functions described in each block of the block diagrams or each step of the flow diagrams. Since computer program instructions may also be installed on the computer device or other programmable data processing equipment, it is also possible to generate a process for performing a series of operation steps on the computer device or other programmable data processing equipment and provide the steps for performing the functions described in each block of the block diagrams and each step of the flow diagrams is displayed.

Hereinafter, various embodiments of the present invention are described in detail, with reference to the accompanying drawings.

(Embodiment 1-1) The present invention relates to a method for supporting self-directed learning by students by helping students who have studied with or learned from textbooks, workbooks, or storybooks to outline and organize (e.g., summarize) what they have studied or learned on their own, to thereby improve their learning efficiency with respect to the contents of the textbooks, workbooks, or storybooks. Here, the content of the textbook is displayed or listed in subdivisions as a plurality of main contents (table-of-contents, index, heading, etc.) and a plurality of sub-contents, wherein the sub-content is a sub-section of the main contents, and the sub-contents subdivide the content of the already learned or studied textbook and guides the students, by individually subdividing the content of the textbook listed or included in the sub-units according to its subject matter and making suggestions or hinting the students thereof. Also provided is a worksheet with blank spaces that allows students to summarize and write down the subject matter corresponding to the sub-content. Further provided is a mind map sheet that includes a vertical, central blank space for writing the main contents corresponding to the main unit, and a horizontal, side blank space located on a side of the central blank space so that the subject matter and the sub-content may be written and filled in together. Based on these, and using the worksheet and the mind map sheet, the method for supporting self-directed learning by students may comprise: a step of providing the worksheet so that a student who has studied the textbook may recall and review the subject matter described in the sub-units; and a step of providing the mind map sheet so that a student who has written a summary of the subject matter in the blank space of the worksheet may combine, combine and summarize a plurality of the subject matters described in the main units of the textbook.

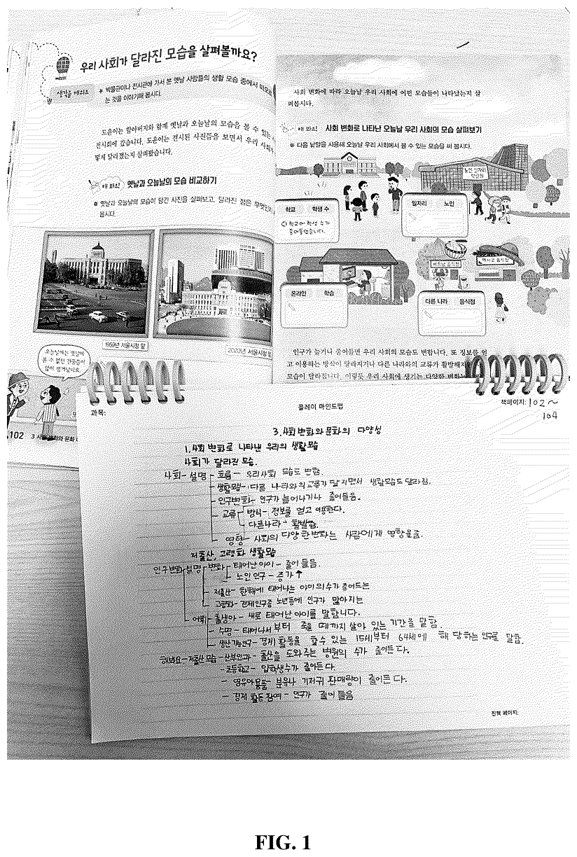

As shown in FIG. 1, the experience of writing a summary of the contents learned by students who have studied with textbooks, workbooks, storybooks, etc. with the students' own hands offers a significant learning effect on the students. The present invention helps the students acquire this experience more easily. This is described in detail as follows.

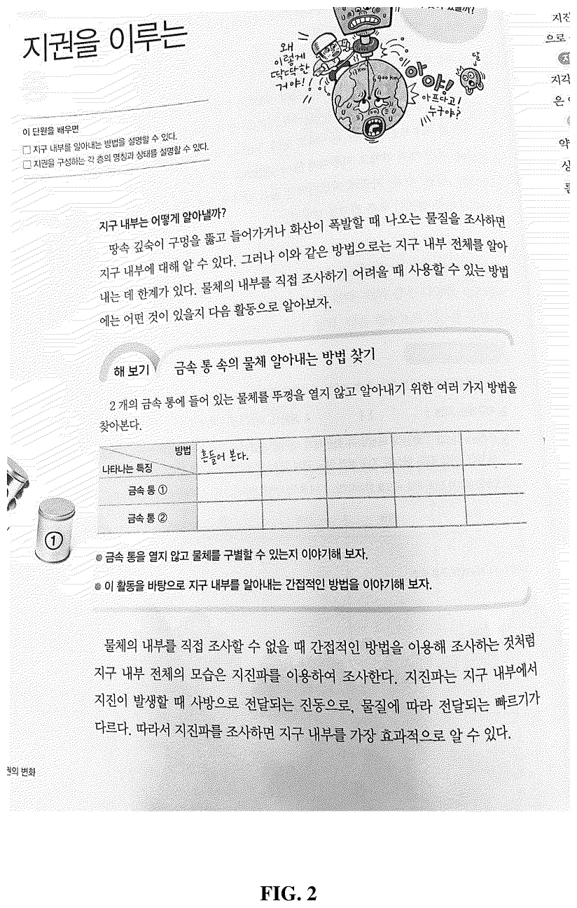

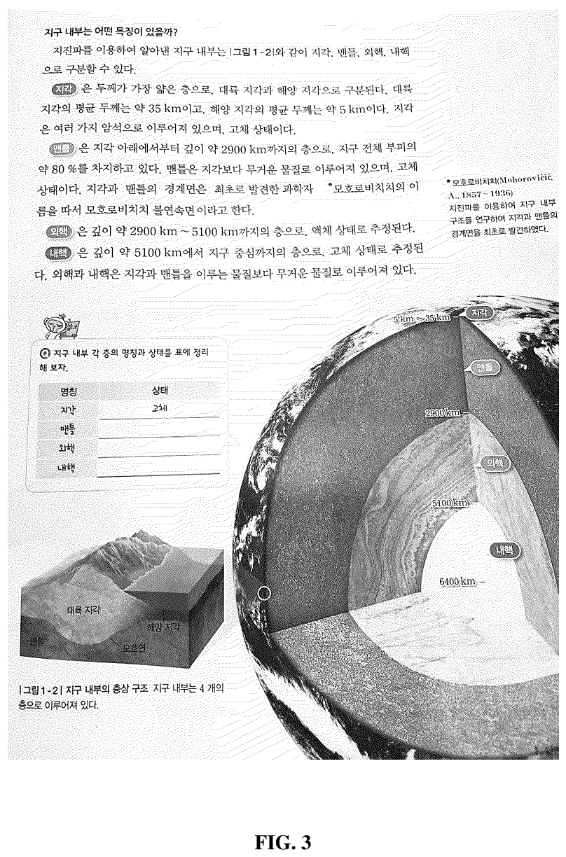

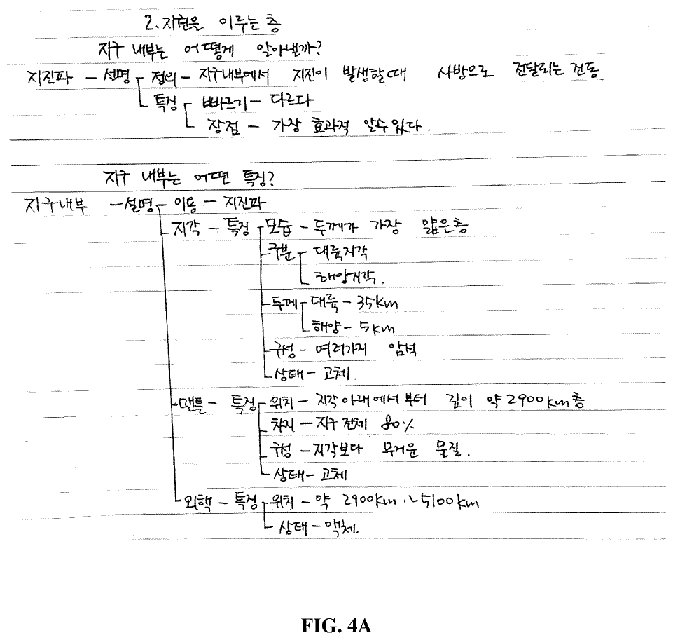

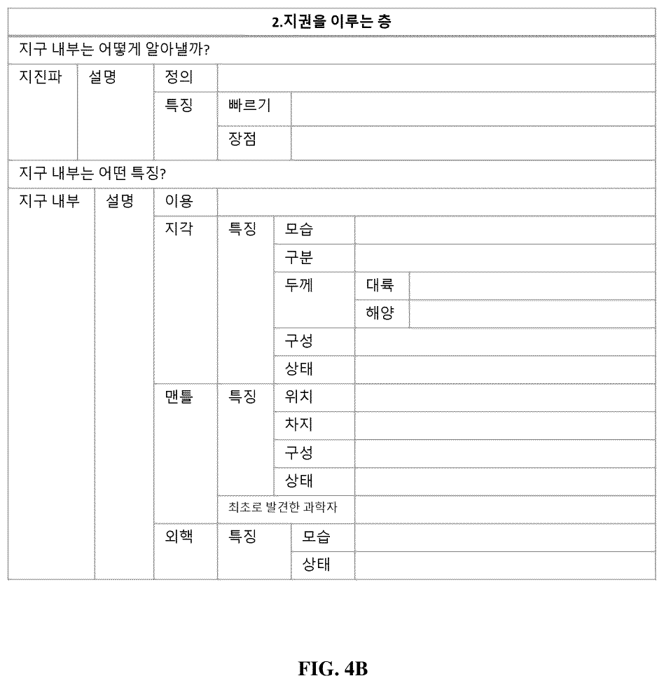

First, as shown in FIG. 2 and FIG. 3 and FIG. 4A, textbooks studied by students are usually divided into a main unit and sub-units, which are sub-sections of the main unit, and the content of the textbook is arranged accordingly. Outlining and organizing such content of the textbook, a summary may be written as shown in FIG. 4B.

As shown in FIG. 4B, the present invention provides sub-contents, which subdivide the content of the already learned or studied textbook and guides the students, by individually subdividing the content of the textbook listed or included in the sub-units according to its subject matter and making suggestions or hinting the students thereof, and a worksheet with blank spaces that allows students to summarize and write down the subject matter corresponding to the sub-contents. In such way, the students are allowed to review and recall what they have learned by directly writing down the subject matter they have already learned in the blank spaces on the worksheet.

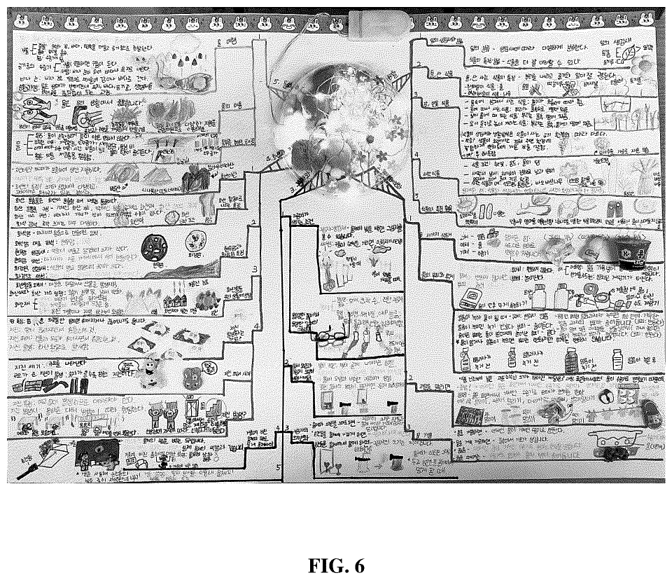

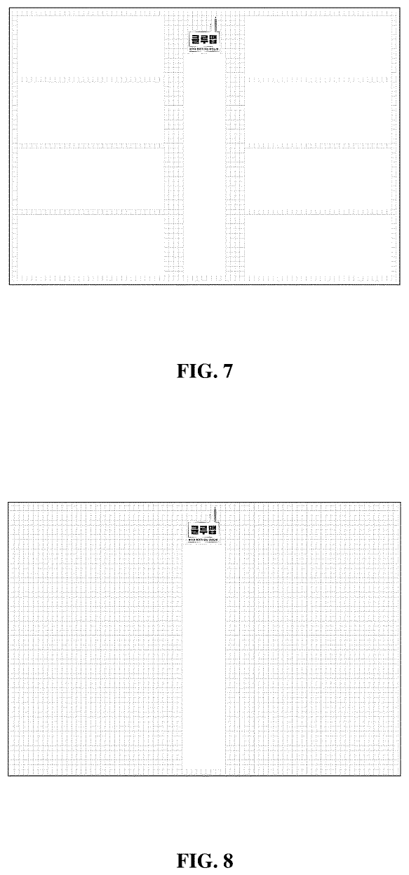

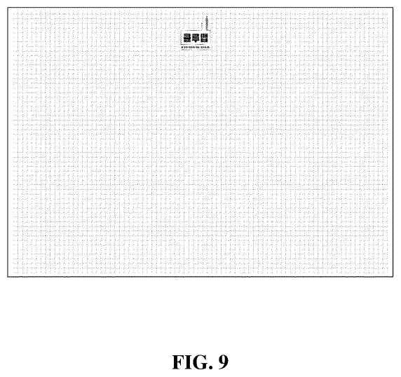

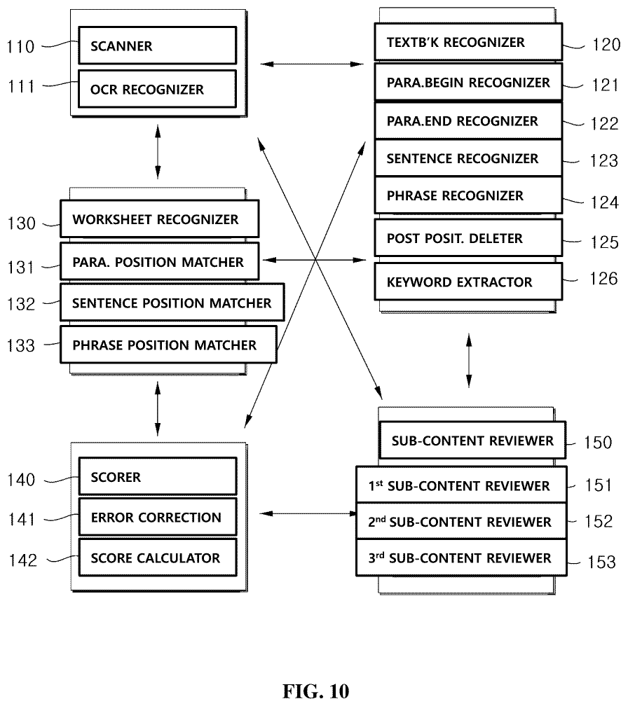

When the students complete the worksheet for the sub-units through this process, the students are able to write the contents of the main unit on the students' own, as shown in FIG. 6, by combining the contents of the sub-units learned. For this, the present invention further provides a mind map sheet, as shown in FIG. 7.

The mind map sheet includes a vertical, central blank space for writing the main contents corresponding to the main unit, and a horizontal, side blank space located on a side of the central blank space so that the subject matter and the sub-contents may be written and filled in together. Using this, the students may be able to easily organize a mind map as shown in FIG. 6. The mind map sheet may have only a central blank space as shown in FIG. 8 and FIG. 9, respectively, or may be configured only in the form of a grid paper. These differences may be appropriately changed depending on the type of subjects or a number of the sub-units to be summarized.

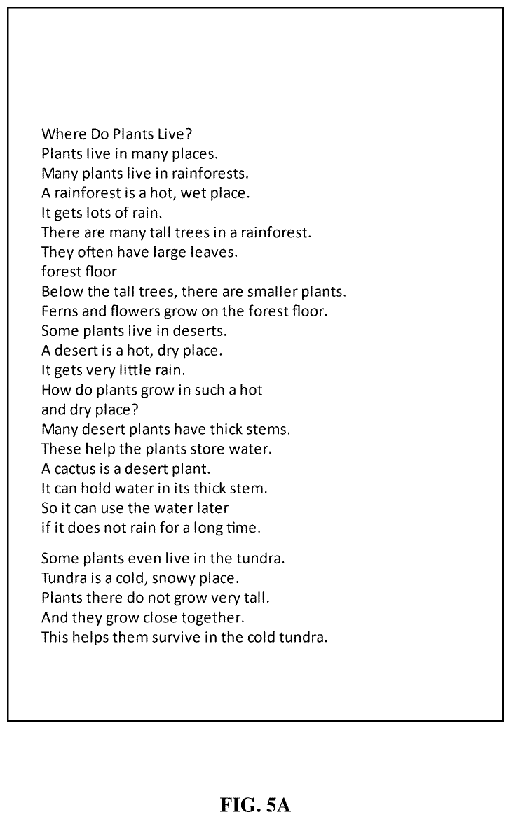

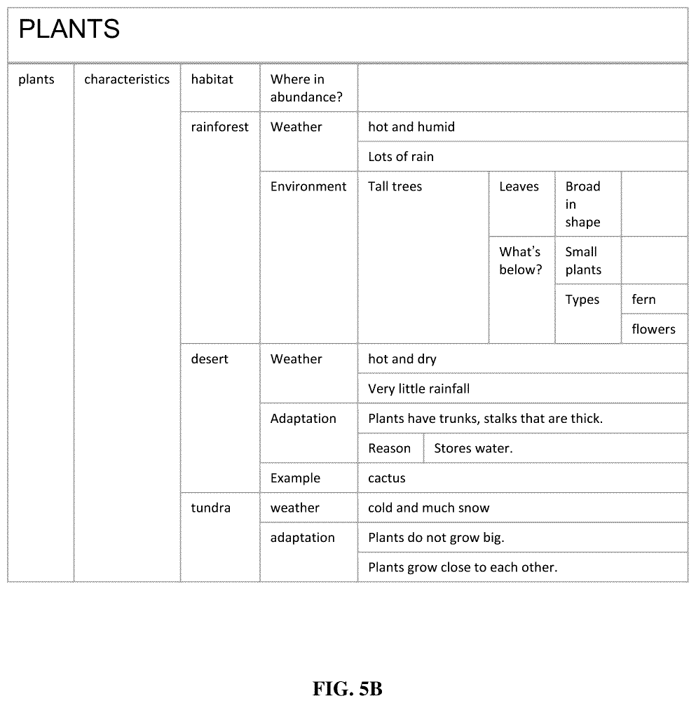

**The textbooks and the hand-written summary, as well as the student worksheet shown, for example, in FIG. 1 through FIG. 4A, 4B and FIG. 6 are in Korean language, as was used in the Korean patent application counterpart of the present disclosure (to which the benefit of priority is claimed).** Nonetheless, a person having ordinary skills in the art would easily understand the layout and structure of the text in the textbook and the summary and the worksheet as described in detail hereafter. To better illustrate this understanding, a page from a science textbook in English language and the corresponding student worksheet, both in English language, are shown in FIG. 5A and FIG. 5B respectively.

(Embodiment 2-1) According to another embodiment, the present invention may comprise: a step of a scanning unit (110) scanning the worksheet on which the student summarizes the subject matter (of the textbook) and the textbook; a step of an OCR-recognizing unit (111) OCR-recognizing the respective contents of a scanned copy of the worksheet and a scanned copy of the textbook and converting the respective contents into digital text; a step of a textbook recognizing unit (120) extracting one or more keywords of or relating to the subject matter from a digital text copy of the textbook; a step of a worksheet recognizing unit (130) searching sub-contents of a digital text copy of the worksheet for a sub-content matching the keyword or keywords extracted by the textbook recognizing unit (120) and recognizing a location of the sub-content; a step of a grading unit (140) comparing whether a text within a blank space next to the sub-contents of the worksheet matches another keyword in the textbook, when the location of the sub-content in the worksheet that matches the keyword of the textbook is recognized; and a step of a sub-content reviewing unit (150) deleting the sub-content in the digital text copy of the worksheet and checking whether a text matching the sub-content is input by the student.

Through a process such as the one above, the present invention may enable one (e.g., a teacher) to easily grade the answers or contents that the students have written themselves on paper worksheets and mind map sheets, or have the students take a more macroscopic view of the contents that they have learned.

(Embodiment 2-2) In the Embodiment 2-1, the step of the textbook recognizing unit (120) extracting one or more keywords of or relating to the subject matter from the digital text copy of the textbook may (further) comprise: a step of a paragraph beginning-point recognizing unit (121) recognizing a position of a first appearing word or first appearing syllable of the word of a text in the digital text copy of the textbook, and when the first appearing syllable of the text (or a target syllable) is located toward a right side of a first appearing syllable of a text located on a line immediately above or below the text (e.g., the line where the target syllable is located), recognizing the first syllable (of the word) of the text (the target syllable) as a beginning point of a paragraph; a step of a paragraph ending-point recognizing unit (122) recognizing a period (i.e., “.” punctuation mark) and blank spaces in the digital text copy of the textbook, and when there are three or more such spaces after the period in a sentence, recognizing the period in the sentence as an ending point of the paragraph; a step of a sentence recognition unit (123) recognizing one period (1st period) as a beginning point of a sentence in the digital text copy of the textbook and another period (2nd period), which is a/the first appearing period after the 1st period, as an ending point of the sentence, and then recognizing the text between the 1st period and the 2nd period as one sentence; a step of a phrase recognition unit (124) recognizing a comma and characters or term after the comma, and when the characters or term after the comma is one of a conjunction (part of speech), such as “by”, “as”, “then”, “and”, “so”, etc., text after the comma and the text before the comma are each recognized as a phrase; and a step of a postposition deleting unit (125) deleting a postposition (part of speech, or grammatical particles indicating relationship between a noun, pronoun or other elements in a sentence) characters or term in the copy of the digital text; and a step of a keyword extracting unit (126) extracting as a keyword or keywords in the text remaining in the copy of the digital text after the deleting step.

In the present invention, paragraphs in the textbook are easily recognized through the paragraph beginning-point recognition unit (121) and the paragraph ending-point recognition unit (122).

In the present invention, sentences in the textbooks are easily recognized through the sentence recognition unit (123).

In the present invention, phrases in the textbooks are easily recognized through the phrase recognition unit (124).

In the present invention, preparation for extracting core keywords from the content or subject matter of the textbook is carried out through the postposition deleting unit (125).

In the present invention, the core keywords are extracted from the content or subject matter of the textbook through the keyword extracting unit (126).

(Embodiment 2-3) In the Embodiment 2-2, the step of the worksheet recognizing unit (130) searching sub-content of the digital text copy of the worksheet for the sub-content matching the keyword or keywords extracted by the textbook recognizing unit (120) and recognizing the location of the sub-content (further) comprises: a step of a paragraph location matching unit recognizing a 1st keyword extracted from a 1st paragraph of the textbook recognized by the paragraph beginning-point recognition unit (121) and the paragraph ending-point recognition unit (122), and searching the digital text copy of the worksheet for a 1st sub-content matching the 1st keyword; a step of a sentence location matching unit recognizing a 2nd keyword extracted from a 1st sentence of the textbook recognized by the sentence recognition unit (123), and searching the digital text copy of the worksheet for a 2nd sub-content, which is a subsection of the 1st sub-content, matching the 2nd keyword; and a step of a phrase location matching unit recognizing a 3rd keyword from a 1st phrase of the textbook recognized by the phrase recognition unit (124), and searching the digital text copy of the worksheet for a 3rd sub-content, which is a subsection of the 2nd sub-content, matching the 3rd keyword.

In the present invention, the position of the worksheet to be compared with the subject matter of the textbook are recognized through the above-described process.

(Embodiment 2-4) In the Embodiment 2-3, the step of the grading unit (140) comparing whether a text within the blank space next to the sub-contents of the worksheet matches another keyword in the textbook, when the location of the sub-content in the worksheet that matches the keyword of the textbook is recognized (further) comprises: a step of a corrective measure determining unit (141) comparing to see whether a 4th keyword, 5th keyword, and 6th keyword extracted from the first paragraph, first sentence, and first phrase match the text in the blank space next to the 1st sub-content, 2nd sub-content, and 3rd sub-content, respectively; and a step of a score calculation unit (142) calculating the number of matches between the fourth keyword, the fifth keyword, and the sixth keyword with the text in the blank space.

The present invention easily identifies shortcomings in a student's learning through the above-described process. For this purpose, the corrective measure determining unit (141) uses the 1st, 2nd, and 3rd sub-contents extracted from the above-described paragraphs, sentences, and phrases, as well as other keywords, such as the 4th keyword, the 5th keyword, and the 6th keyword to compare whether each keyword matches the text in the blank space next to the 1st, 2nd and 3rd sub-contents.

Thereafter, the score calculating unit (142) calculates a number of matches between the 4th keyword, 5th keyword, and 6th keyword with the text in the blank space.

(Embodiment 2-5) In the Embodiment 2-4, the step of the sub-content reviewing unit (150) deleting the sub-content from the digital text copy of the worksheet and checking whether a text matching the sub-content is input by the student may (further) comprise: a step of a 3rd sub-content reviewing unit (153) deleting the 3rd sub-content from the digital text copy of the worksheet and checking whether the text matching the 3rd sub-content is input by the student, when the 4th keyword, 5th keyword, and 6th keyword all match the text in the blank space; a step of a 2nd sub-content reviewing unit (152) deleting the 2nd sub-content from the digital text copy of the worksheet and checking whether the text matching the 2nd sub-content is input by the student, when the text matching the 3rd sub-content is input; and a step of 1st sub-content reviewing unit (151) deleting the 1st sub-content from the digital text copy of the worksheet and checking whether the text matching the 1st sub-content is input by the student, when the text matching the 2nd sub-content is input.

Through the above-described process, the present invention enables students who write all of the correct answers in the blank spaces on the worksheet to write down additional sub-contents, so that they get a comprehensive view of the overall flow of the textbook's subject matter.

And thereafter, by providing students with the mind map sheet as described above, the students may be led to organize the subject matter of the sub-contents learned thus far and comprehensively write down the subject matter of the main contents, as shown in FIG. 6.

To note, in addition to paper form, the above-described worksheet and mind map sheet may be output directly, for example, on a tablet PC screen and also implemented in a form where the students writes text directly on the tablet PC. In such case, since digital text is directly entered or input onto the blank spaces of the worksheet, the process of scanning and OCR recognition of the worksheet via the scanning unit (110) and the OCR recognizing unit (111) may be omitted.

(Embodiment 3-1) The present invention is a method for supporting self-directed mathematics learning that improves a student's math learning efficiency by conveying the concept of four arithmetic operations to students using math tools and reviewing what they have learned about four arithmetic operations using a mind map sheet. The math tool is made of a rectangular fabric material and is divided along the length into an upper area (161), a central area (162), and a lower area (163), and the math tool comprises: a foldable body (160), wherein wrinkles (164) are formed along the width direction between the upper area (161) and the central area (162) and between the central area (162) and the lower area (163), so that the lower area (163) is overlappingly foldable with the central area (162) and the central area (162) and the upper area (161) are again overlappingly foldable; a pocket (165) arranged at the central area (162) at an outer surface of the foldable body (160); stickers (166) arranged at the pocket (165) and marked with natural numbers 1 through 150; a female-type snap button arranged at an outer surface of the pocket (165); a strap cover extending from the upper area (161) of the foldable body (160); a male-type button arranged at the strap cover (167) and to be coupled with the female-type button when the foldable body (160) is in a folded state; a shoulder strap (168) extending from the strap cover (167); and a number array board (169) provided at an inner surface of the foldable body (160). The number array board (169) is configured as rectangular spaces that is arranged in 10 columns along the width direction and 15 rows along the length direction, and for a total of 150, wherein the stickers (166) are individually attachable and detachable thereto; and comprises red reference lines consisting of the boundaries of the 5th and 6th columns; black 1st-row reference line consisting of boundary line between the 5th and 6th rows; and a pink 2nd-row reference line formed as a boundary line between the 10th and 11th rows of the spaces among the boundary lines forming the spaces. The mind map sheet comprises a vertical central blank space provided to write down a table of contents or contents representing the subject matter learned through the math tool, and a grid area located on a side of the central blank space and provided to write down details of the subject matter learned through the math tool. And the method for supporting self-directed learning comprises a step of providing the math tools to enable a student to learn the concept of the four basic arithmetic operation, and providing the mind map sheet so that the student who has learned the concept of four arithmetic operations through the mathematics tool is able to accumulate and summarize the subject matter already learned.

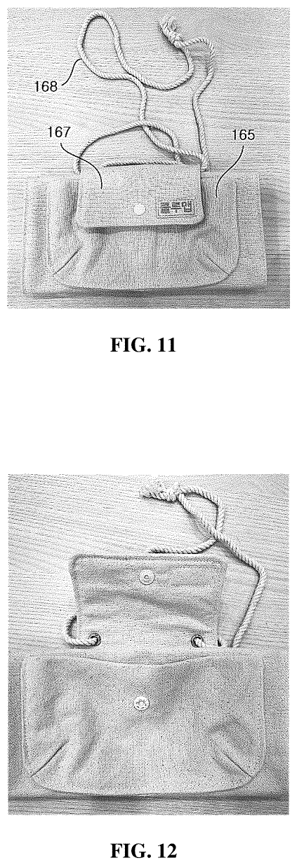

The present invention may easily convey the concept of 4 arithmetic operations to students using mathematics tools. Here, the math tools may be modified as a handbag-type form as shown in FIG. 11 and configured so that they are easy to carry by students.

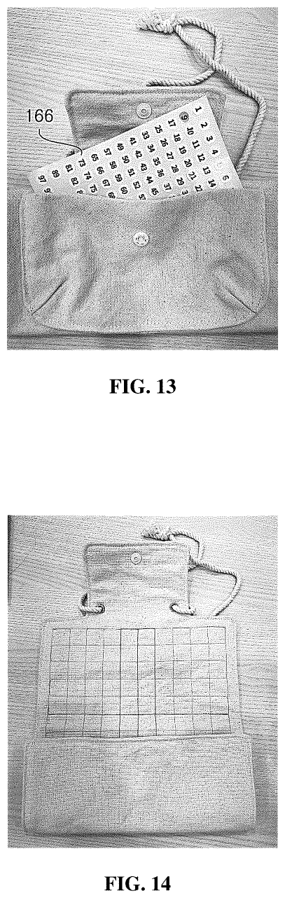

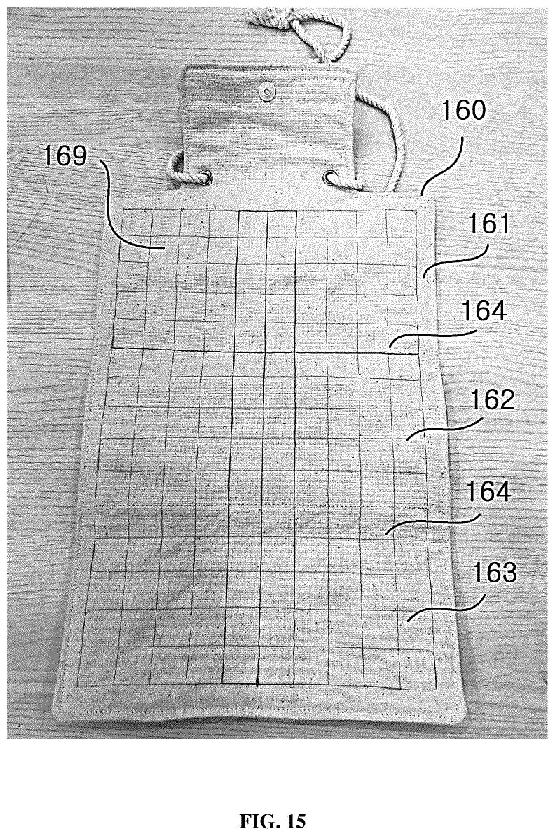

The math tools of the present invention is configured so that it is able to open up by unfolding the strap cover (167) and putting the strap cover aside, as shown in FIG. 12. In this case, the pocket (165) is provided with the sticker (166) with a natural number attached, as shown in FIG. 13. The foldable body (160) is divided into the upper area (161), the central area (162), and the lower area (163) along the length direction, as shown in FIG. 15, and the wrinkles (164) are formed along the width direction between the upper area (161) and the central area (162) and between the central area (162) and the lower area (163), so that the foldable body (160) may be easily folded, as shown in FIG. 14.

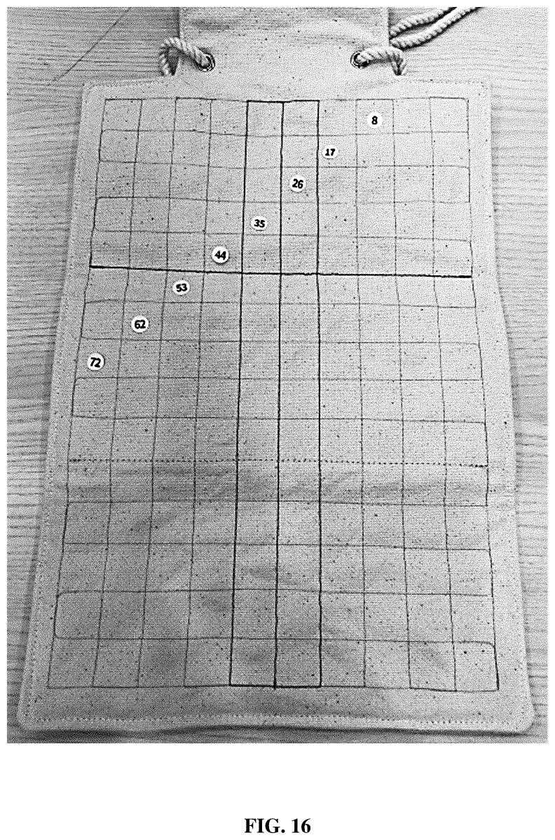

The number-array board (169) is provided on the inner surface plane of the foldable body (160), as shown in FIG. 15. The number-array board (169) is configured so that stickers (166) may be attached thereto, as shown in FIG. 16, so that the concept of 4 arithmetic operations may be easily conveyed to students.

Meanwhile, the reference lines of the 5th and 6th columns among the boundary lines of the number array board (169) may be colored in red or a dark color or in bold, allowing students to easily distinguish how many spaces they move to the left and the right. In addition, the 1^{st} row reference line between the 5th and 6th rows may be colored in black, and the 2nd row reference line between the 10th and 11th rows may be colored in pink, making it easy for students to distinguish and know how many spaces they move up and down.

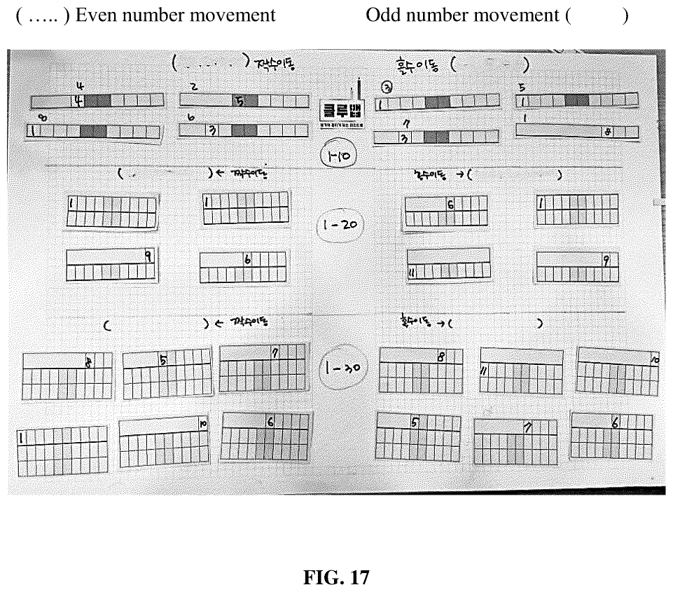

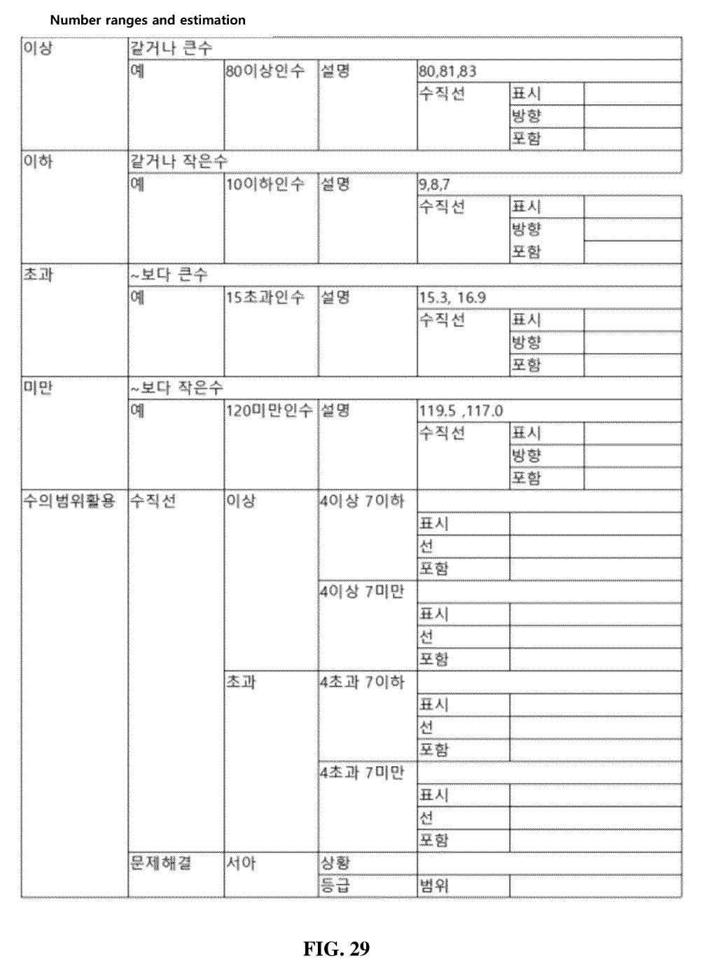

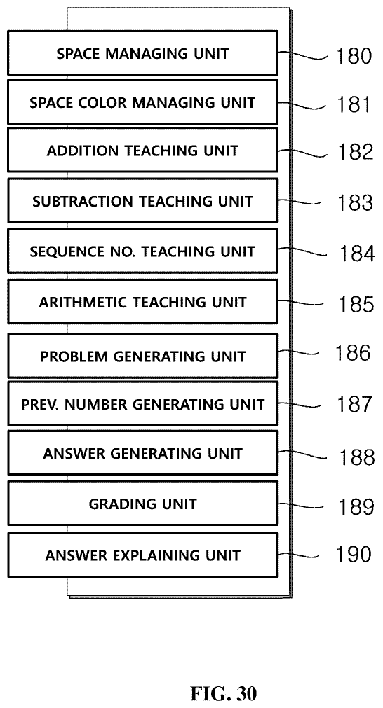

As shown in FIG. 17, the mind map sheet of the present invention may be used to fill in the central blank space, the contents or the table of contents representing what was learned through the math tools, and in the grid area, may also write down details of what was earned through the math tool, so students who have learned the concepts of the 4 arithmetic operations through the math tool are able to combine and summarize what they have already learned. Such mind map sheet may be used in the same way as in an embodiment using a tablet PC, which will be described later. Of course, as in the above-described embodiment, the present invention may also use the worksheet shown in FIG. 29 to allow students to summarize what they have learned through the math tool.

(Embodiment 4-1) The method according to an embodiment of the present invention comprises: a step of a space (e.g., a “box” or cell in the number array board) managing unit (180) creating rectangular spaces arranged in 10 columns along the width direction and 1 to 15 rows along the length direction on the tablet PC screen; a step of a space color managing unit (181) changing the 5th and 6th columns of the spaces to a first color; a step of an addition teaching unit (182) performing a process to educate a student on the addition operation of A+B=C (where A, B, C are natural numbers) using the spaces; The student is able to access the addition teaching unit (182); a step a subtraction teaching unit (183) performs a process to educate the student on the subtraction operation of D−E=F (where D, E, F are natural numbers) using the spaces, when the student passes the processes by the addition teaching unit (182); a step of a sequence number teaching unit (184) using the spaces to educate the student on operation of Gₙ+H=Gₙ₊₁ (where Gₙ, H, Gₙ₊₁, n are natural numbers) performing a process to educate the student on the sequence number arithmetic or operation, when the student passes the process by the subtraction teaching unit (183); and a step of an arithmetic teaching unit (185) performing a process to educate the student on arithmetic operations using (the) numbers alone when the student passes the process by the sequence number teaching unit (184).

The present invention may also be implemented using a tablet PC, and hereinafter, specific examples of Embodiment 4-1 are described.

(Embodiment 4-2) In the Embodiment 4-1, the step of the addition teaching unit (182) performs a process to teach the addition operation of A+B=C to the student using the rectangular spaces (further) comprises: a step of a problem generating unit (186) outputting an addition problem of “A+B=” (A, B, A+B are natural numbers less than 10) on a screen of the tablet PC; a step of a space managing unit (180) displaying creating rectangular spaces (or cells) arranged as 10 columns and 1 row on the tablet PC screen; a step of a previous-number generating unit (187) outputting the natural number A in the Ath space of the 1 row; a step of a space managing unit (180) deleting 1st through (A−1)th space in the 1 row; a step of the answer generating unit (188) repeatedly outputting the natural number (A+B) in the

Ath space alternately with the natural number A; a step of a grading unit (189) checking whether the natural number (A+B) output in the Ath space is dragged and placed in the (A+B)th space by the student; a step of an answer explaining unit (190) sequentially outputting the natural numbers 1 through B from the (A+1)th space to the (A+B)th space, when the natural number A+B output in the Ath space is dragged and placed in a space other than the (A+B)th space; a step of the problem generating unit (186) outputting “A1+B1=”(A1, B1, A1+B1 are natural numbers less than or equal to 20) on the tablet PC screen; a step of the outputting an addition problem, when the natural number (A+B) output in the Ath space is dragged and placed in the (A+B)th space; a step of the space managing unit (180) creating a rectangular space arranged as 10 columns and 2 rows on the tablet PC screen; a step of the previous-number generating unit (187) outputting the natural number A1 in the (A1)th space of the 2 rows; a step of the space managing unit (180) deleting the spaces from the 1st to (A1−1)th rows among the 2 rows; a step of the answer generating unit (188) repeatedly outputting the natural number (A1+B1) in the (A1)th space, alternating with the natural number A1; a step of the grading unit (189) checking whether the natural number (A1+B1) output in the (A1)th space is dragged and placed in the (A1+B1)th space by the student; a step of the answer explaining unit (190) sequentially outputting the natural numbers 1 through B1 in the (A1+1) space to the (A1+B1)th space, when the natural number (A1+B1) output in the (A1)th space is dragged and placed in a space other than the (A1+B1)th space; and a step of outputting natural numbers up to B1; and a step of the problem generating unit (186) outputting an addition problem of “A2+B2=”(A2, B2, A2+B2 are natural numbers less than or equal to 30), when the natural number (A1+B1) output in the (A1)th space is dragged and placed in the (A1+B1)th space.

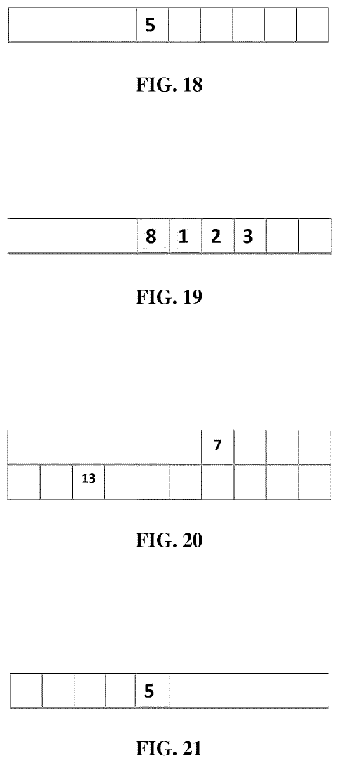

The addition operation learning method according to the present invention is described with examples as follows. First, when the problem generating unit (186) outputs the addition problem of “5+3=” on the tablet PC screen, the space managing unit (180) creates rectangular spaces arranged in 10 columns and 1 row, as shown in FIG. 18. Afterwards, the previous number generating unit (187) outputs the natural number 5 in the 5th space, and the space managing unit (180) deletes the 1st to 4th spaces. Deletion of these spaces serves a function of preventing confusion among students.

Afterwards, the answer generating unit (188) makes an output by blinking the correct answer, 8, alternately with the previous number, 5, in the 5th space. The student is able to drag the correct answer, 8, and move it to the 8th space, which is the correct answer. At this time, the scoring unit (189) checks whether 8 in the 5th space is dragged and placed in the 8^{th} space. Here, when the student drags and places the correct answer, 8, into another space, the answer explaining unit (190) sequentially outputs natural numbers from 1 to 3 from the 6th to the 8th space, as shown in FIG. 19. Through this, the student is able to easily recognize the concept of +3.

When the student drags and places the correct answer, 8, into the 8th space, the problem generating unit (186) outputs more difficult addition problem of “7+6=”. In this case, the space managing unit (180) creates a rectangular space arranged in 10 columns and 2 rows as shown in FIG. 20, and the previous number generating unit (187) outputs the natural number 7 in the 7^{th} space, and the space managing unit (180) deletes the 1st through 6th spaces.

Afterwards, the answer generating unit makes an output by blinking the correct answer, 13, in the 7th space, alternately with the previous number, 7. If the student drags 13, which is the correct answer, and moves it to the 13th space, which is the correct answer, as shown in FIG. 20, the problem generating unit (186) may output a more difficult problem, an addition problem involving answer of 30 or less, and the subsequent process is as described above 30 or less, and the subsequent process is as described above.

(Embodiment 4-3) In the Embodiment 4-1, when the student passes the process by the addition teaching unit (182), the step of the subtraction teaching unit (183) performing a process to teach the subtraction operation of D−E=F (where D, E, F are natural numbers) to the student using the rectangular spaces (further) comprises: a step of a problem generating unit (186) outputting a subtraction problem of “D−E=” (D, E, F are natural numbers less than 10) on a screen of the tablet PC; a step of a space managing unit (180) displaying creating rectangular spaces (or cells) arranged as 10 columns and 1 row on the tablet PC screen; a step of a previous-number generating (187) outputting the natural number D in the Dth space of the 1 row; a step of a space managing unit (180) deleting 10th through (D+1)th space in the 1 row; a step of the answer generating unit (188) repeatedly outputting the natural number (D−E) in the Dth space alternately with the natural number D; a step of a grading unit (189) checking whether the natural number (D−E) output in the Dth space is dragged and placed in the (D−E)th space by the student; a step of an answer explaining unit (190) sequentially outputting the natural numbers 1 through E from the (D−1)th space to the (D−E)th space, when the natural number (D−E) output in the (D−E)th space is dragged and placed in a space other than the (D−E)th space; a step of the problem generating unit (186) outputting a subtraction problem “D−E=”(D, E, F are natural numbers less than 20) on the tablet PC screen, when the natural number (D−E) output in the Dth space is dragged and placed in the (D−E)th space; a step of the space managing unit (180) creating a rectangular space arranged as 10 columns and 2 rows on the screen of the tablet; a step of the previous-number generating unit (187) outputting the natural number D1 in the (D1)th space of the 2 rows; a step of the space managing unit (180) deleting the spaces from the 20th to (D1+1)th rows among the 2 rows; a step of the answer generating unit (188) repeatedly outputting the natural number (D1−E1) in the (D1)th space, alternating with the natural number A1; a step of the grading unit (189) checking whether the natural number (D1−E1) output in the (D1)th space is dragged and placed in the (D1−E1)th space by the student; a step of the answer explaining unit (190) sequentially outputting the natural numbers 1 through E1 in the (D1−1) space to the (D1−E1)th space, when the natural number (D1−E1) output in the (D1)th space is dragged and placed in a space other than the (D1−E1)th space; and a step of the problem generating unit (186) outputting a subtraction problem of “D2−E2=”(D2, E2, D2−E2 are natural numbers less than 30), when the natural number (D1−E1) output in the (D1)th space is dragged and placed in the (D1−E1)th space.

The method for learning the subtraction operation according to the present invention is described with examples as follows. First, when the problem generating unit (186) outputs a subtraction problem of “5−3=” on the tablet PC screen, the space managing unit (180) creates a rectangular space arranged in 10 columns and 1 row, as shown in FIG. 21. Afterwards, the previous number generating unit (187) outputs the natural number 5 in the 5th space, and the space managing unit (180) deletes the 6th through 10th spaces. Deletion of these spaces serves to prevent confusion when students learn subtraction.

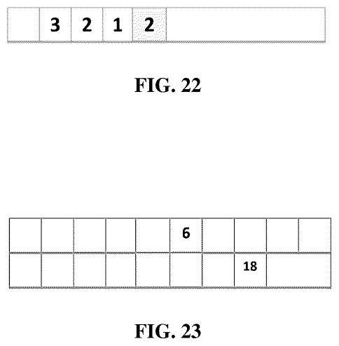

Afterwards, the answer generating unit (188) outputs the correct answer, 2, in the 5th space, blinking alternately with the previous number, 5. The student may drag the correct answer, 2, and move it to the second correct answer space. At this time, the scoring unit (189) checks whether 2 in the 5th column is dragged into the 2nd space. Here, when the student drags the correct answer, 2, to another space, the answer explaining unit (190) sequentially outputs natural numbers from 1 to 3 from the 4th space to the 2nd space, as shown in FIG. 22. Through this, the student is able to easily recognize the concept of −3.

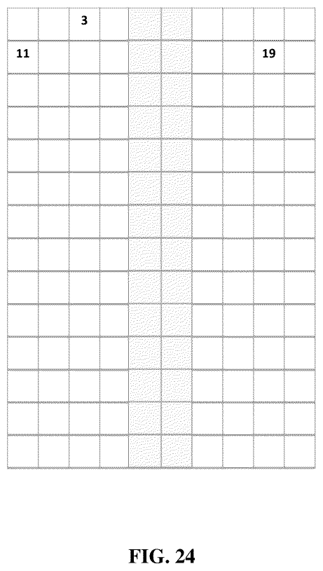

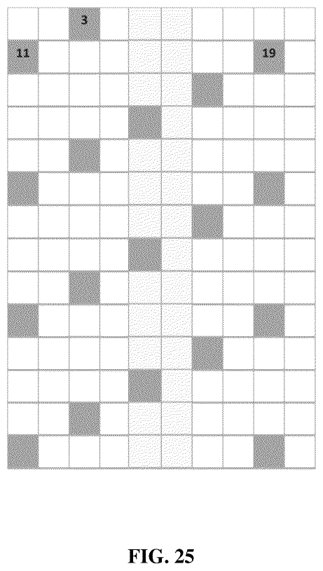

If the student drags and places the correct answer, 2, into the second space, the problem generating unit (186) outputs more difficult subtraction problem of “18−12=”. In this case, the space managing unit (180) creates a rectangular space arranged in 10 columns and 2 rows as shown in FIG. 23, and the previous-number generating unit (187) outputs the natural number 18 in the 18th space, and the space managing unit (180) deletes the 19th to 20th spaces.

Afterwards, the answer generating unit (188) outputs the correct answer, 6, in the 18th space, blinking alternately with the previous number, 18. If the student drags 6, which is the correct answer, and moves it to the 6th space, which is the correct answer, as shown in FIG. 23, the problem generating unit (186) may output a more difficult subtraction problem involving answer of 30 or less, and the subsequent process is as described above.

(Embodiment 4-4) In the Embodiment 4-1, when the student passes the process by the subtraction teaching unit (183), the step of the sequence number teaching unit (184) performing a process to teach the sequence number operation of Gn+H=Gn+1 (where Gn, H, Gn+1, n are natural numbers) to the student using the rectangular spaces (further) comprises: a step of the problem generating unit (186) outputting a sequence number problem of “Gn+H=” (Gn, H, Gn+1, n are natural numbers) on a screen of the tablet PC; a step of the space managing unit (180) displaying creating rectangular spaces (or cells) arranged as 10 columns and 15 rows on the tablet PC screen; a step of the previous-number generating (187) outputting the natural number Gn in the (Gn)th space of the 15 row; a step of the space managing unit (180) deleting 1st through (Gn−1)th space in the 1 row; a step of the answer generating unit (188) repeatedly outputting the natural number (Gn+H) in (Gn)th space alternately with the natural number Gn; a step of the grading unit (189) checking whether the natural number (Gn+H) output in the (Gn)th space is dragged and placed in the (Gn+H)th space by the student; a step of the answer explaining unit (190) sequentially outputting the natural numbers 1 through H from the (Gn+1)th space to the (Gn+H)th space, when the natural number (Gn+H) output in the (Gn)th space is dragged and placed in a space other than the (Gn+H)th space; a step of the problem generating unit (186) outputting a sequence number problem “Gn+1+H=”(Gn+1=Gn+H) on the tablet PC screen, when the natural number (Gn+H) output in the (Gn)th space is dragged and placed in the (Gn+H)th space; a step of the previous-number generating unit (187) outputting the natural number (Gn+1) in the (Gn+1)th space of the 15 rows; a step of the answer generating unit (188) repeatedly outputting the natural number (Gn+1+H) in the (Gn+1)th space, alternating with the natural number Gn+1; a step of the grading unit (189) checking whether the natural number (Gn+1+H) output in the (Gn+1)th space is dragged and placed in the (Gn+1+H)th space by the student; and a step of the space color managing unit (181) changes (Gn+m)th space (Gn+m+1=Gn+m +H, m is a natural number including 0) among the 15 rows into a 2nd color, when the natural number (Gn+1+H) output in the (Gn+1)th space is dragged and placed in the (Gn+1+H)th space.

The method of learning a sequence of numbers according to the present invention is descried with examples as follows. Here, the sequence of numbers refer to an operation that repeatedly adds the same number to the previous number.

First, the problem generating unit (186) outputs a sequence number problem of “3+8=” on the tablet PC screen. Afterwards, the space managing unit (180) creates a rectangular space arranged in 10 columns and 15 rows, as shown in FIG. 24 on the tablet PC screen, and the previous number generating unit (187) creates the natural number 3 in the 3rd space.

Afterwards, the answer generating unit (188) outputs the correct answer, 11, in the 3^{rd} space, blinking alternately with the previous number, 3. The student may drag the correct answer, 11, and move it to the 11th correct answer space. Afterwards, the grading unit (189) checks whether the natural number 11 output in the 3rd space is dragged and placed in the 11th space by the student.

Here, when the correct answer, 11, output in the 3rd space is dragged and placed in the 11th space as shown in FIG. 24, the problem generating unit (186) outputs a sequence number problem of “11+8=”. Afterwards, the previous number generating unit (187) outputs 11 in the 11th column, and the answer generating unit (188) outputs the correct answer, 19, in the 11th space alternately with 11 while blinking. Afterwards, the scoring unit (189) checks whether the correct answer 19 output in the 11th space is dragged and placed in the 19th space by the student.

Here, when the correct answer 19 is dragged and placed in the 19th space, the space color management unit (181) outputs the 2nd color to the space corresponding to the sequence number of 8 among all spaces of the number array board, as shown in FIG. 25. As a result, the student is able to easily recognize that the sequence number operation has a certain pattern, and through this, the basic concept of the multiplication operation is easily conveyed to the student. For instance, in the example above, if the previous number starts with 8 instead of 3, this corresponds to the 8th space of the multiplication table. In this way, by appropriately adjusting the previous number and sequence number, the student is able to easily understand the 1st through 9th space (or 1 times to 9 times) of the multiplication tables.

(Embodiment 4-5) In the Embodiment 4-1, when the student passes the process by the sequence number teaching unit (184), the step of the arithmetic teaching unit (185) performing a process to teach arithmetic using numbers themselves (further) comprises: a step of the problem generating unit (186) outputting an addition problem of “A+B=”(A, B, A+B are natural numbers less than 150) on a screen of the tablet PC; a step of a space managing unit (180) displaying creating rectangular spaces (or cells) arranged as 10 columns and 15 rows on the tablet PC screen; a step of a previous-number generating (187) outputting the natural number A in the Ath space of the 15 rows; a step of a space managing unit (180) creating one space by combining (A−1)th, Ath, and (A−1)th spaces; a step of the answer generating unit (188) repeatedly outputting the natural number (A+B) in the Ath space alternately with the natural number A; a step of a grading unit (189) checking whether the natural number (A+B) output in the Ath space is dragged and placed in the (A+B)th space by the student; a step of the problem generating unit (186) outputting an addition problem of “A1+B1=”(A1, B1, A1+B1 are natural numbers less than 150) on the tablet PC screen, when the natural number (A+B) output in the Ath space is dragged and placed in the (A+B)th space; a step of the previous-number generating unit (187) outputting the natural number A1 in the (A1)th space of the 15 rows; a step of the space managing unit (180) creating another space by combining (A1−2)th, (A−1)th, (A1)th, (A1+1)th, and (A1+2)th spaces; a step of the answer generating unit (188) repeatedly outputting the natural number (A1+B1) in (A1)th space alternately with the natural number A1; a step of the grading unit (189) checking whether the natural number (A1+B1) output in the (A1)th space is dragged and placed in the (A1)th space by the student; and a step of the problem generating unit (186) outputting an addition problem of “A2+B2=”(A2, B2, A2+B2 are natural numbers less than 150), when the natural number (A1+B1) output in the (A1)th space is dragged and placed in the (A1+B1)th space; a step of the space managing unit (180) creating another space by combining (A2−2)th, (A−2)th, (A2)th, (A2+1)th, and (A2+2)th spaces; a step of the previous-number generating unit (187) randomly selecting one among the (A2−2)th, (A−2)th, (A2)th, (A2+1)th, and (A2+2)th spaces and outputting the natural number A2 in the randomly selected space; a step of the answer generating unit (188) repeatedly outputting the natural number (A2+B2) in randomly selected space alternately with the natural number A2; and a step of the grading unit (189) checking whether the natural number (A2+B2) output in the randomly selected space is dragged and placed in the (A2+B2)th space by the student.

A next-level arithmetic learning method according to the present invention is described with examples as follows. Students will easily learn the general arithmetic calculation method using the numbers alone based on the calculation learning method below.

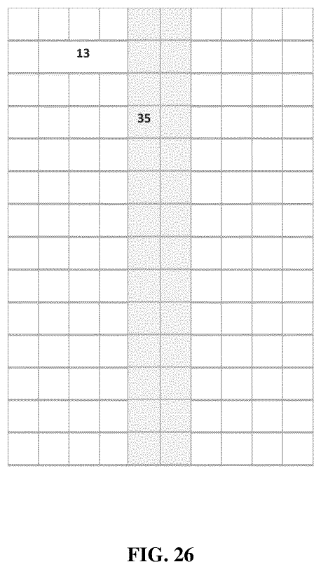

First, the problem generating unit (186) outputs the addition problem of “13+22=” on the tablet PC screen. Afterwards, the previous number generating unit (187) outputs the natural number 13 in the 13th space, as shown in FIG. 26, and the space managing unit (180) merges the 12th, 13^{th}, and 14th spaces to create one space. Then, the answer generating unit (188) outputs the correct answer, 35, in the 13th space, blinking alternately with 13.

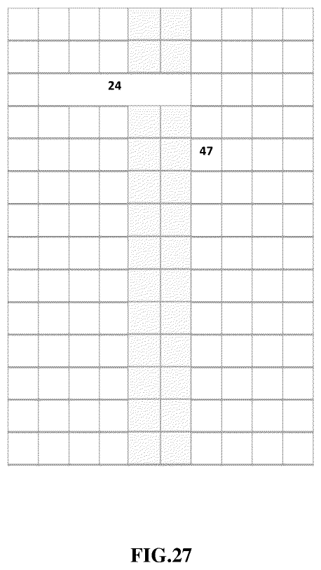

Afterwards, the scoring unit (189) checks whether the correct answer, 35, output in the 13th space is dragged and placed in the 35th space by the student, and if it passes, the problem generating unit (186) again outputs the addition problem “24+23=”. Then, the previous number generating unit (187) outputs the natural number 24 in the 24th space as shown in FIG. 27, and the space managing unit (180) outputs the natural number 24 and merges the 22nd, 23rd, 24^{th}, and 25th spaces to created one space. And then, the answer generating unit (188) outputs the correct answer, 47, in the 24th space, blinking alternately with 24.

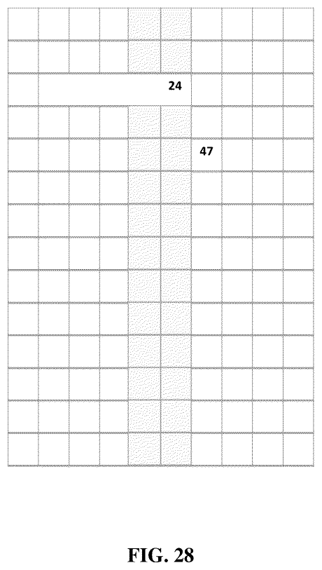

Afterwards, when the correct answer 47 displayed in the 24th space is dragged and placed in the 47th space by the student, the problem generating unit (186) outputs the addition problem of “24+23=” again. Then, the space managing unit (180) generates one space by merging the 22nd column, 23rd column, 24th column, 25th column, and 26th spaces as shown in FIG. 28, and the previous number generator (187) randomly selects one of the 22nd, 23rd, 24th, 25th, and 26th spaces, and outputs the natural number 24 in the randomly selected space (here, the 26th space).

Afterwards, the correct answer generating unit (188) outputs the correct answer, 47, in the 26th space alternately with 24, while blinking, and the scoring unit (189) checks whether the correct answer, 47, is dragged and placed in the 47th space by the student. According to this, since the previous number 24 is displayed in the 26th space rather than the 24th space that matches it, the student is not able to solve the problem by counting the number of spaces (as many as 23) and skipping through one by one, and also as the spaces are merged, the student is gradually be able to break away from the habit of relying only on the number of spaces. Eventually the student will learn the basics of general arithmetic calculations using the numbers alone.

In the present disclosure, various embodiments of the present invention are shown and described. Although particular terminology has been used, such terminology is used in a general sense to facilitate explaining of technical aspects of the present invention and to aid in understanding of the invention, and is not intended to limit the scope of the present invention. In addition to the embodiments disclosed herein, it is self-evident to those skilled in the art that other modifications and variations based on the spirit and technical scope of the present invention may be implemented.

### REFERENCE NUMERALS

110: Scanning Unit
120: Textbook Recognizing Unit
130: Worksheet Recognizing Unit
140: Grading Unit
150: Sub-Content Reviewing Unit
160: Folding-type Main Body

What is claimed is:

1. A method for supporting self-directed learning by student to help student who has studied with textbooks, workbooks, or storybooks to outline and organize what was learned, to thereby improve learning efficiency with respect to contents of the textbooks, workbooks, or storybooks, wherein the contents of the textbook is arranged in divisions of main units and sub-units of the main units, or in subdivisions as a plurality of main contents and a plurality of sub-contents, where the sub-content is a sub-section of the main contents,
the method comprising:
a step of providing a worksheet so that a student who has studied with the textbook recalls and reviews the subject matter described in the sub-units,
wherein the sub-contents or sub-table-of-contents items guides the student, by individually subdividing the contents of the textbook listed or included in the sub-units according to its subject matter and making suggestions or hinting the student thereof, and the worksheet includes blank spaces that allows the student to summarize and write down the subject matter corresponding to the sub-contents; and
a step of providing a mind map sheet so that a student who has written a summary of the subject matter in the blank space of the worksheet may combine, aggregate and summarize a plurality of the subject matters described in the main units of the textbook,
wherein a mind map sheet includes a vertical, central blank space for writing the main contents corresponding to the main unit, and a horizontal, side blank space located on a side of the central blank space so that the subject matter and the sub-content may be written and filled in together.

2. The method for supporting self-directed learning by student according to claim 1, further comprising:
a step of a scanning unit (110) scanning the worksheet on which the student summarizes the subject matter of the textbook;
a step of an OCR-recognizing unit (111) OCR-recognizing respective contents of a scanned copy of the worksheet and a scanned copy of the textbook, and converting the respective contents into digital text;
a step of a textbook recognizing unit (120) extracting one or more keywords relating to the subject matter from a digital text copy of the textbook;
a step of a worksheet recognizing unit (130) searching sub-contents of a digital text copy of the worksheet for a sub-content matching the keyword or keywords extracted by the textbook recognizing unit (120) and recognizing a location of the sub-content;
a step of a grading unit (140) comparing whether a text within a blank space next to the sub-contents of the worksheet matches another keyword in the textbook, when the location of the sub-content in the worksheet that matches the keyword of the textbook is recognized; and
a step of a sub-content reviewing unit (150) deleting the sub-content in the digital text copy of the worksheet and checking whether a text matching the sub-content is input by the student.

3. The method for supporting self-directed learning by student according to claim 2, wherein the step of the textbook recognizing unit (120) extracting one or more keywords relating to the subject matter from the digital text copy of the textbook comprises:
a step of a paragraph beginning-point recognizing unit (121) recognizing a position of a first appearing word or first appearing syllable of the word of a text in the digital text copy of the textbook, and when the first appearing syllable of the text (or a target syllable) is located toward a right side of a first appearing syllable of a text located on a line immediately above or below the text, recognizing the first syllable of the word of the text (the target syllable) as a beginning point of a paragraph;
a step of a paragraph ending-point recognizing unit (122) recognizing a period and blank spaces in the digital text copy of the textbook, and when there are three or more such spaces after the period in a sentence, recognizing the period in the sentence as an ending point of the paragraph;
a step of a sentence recognition unit (123) recognizing one period as a beginning point of a sentence in the digital text copy of the textbook and another period, which is a/the first appearing period after the 1st period, as an ending point of the sentence, and then recognizing the text between the 1st period and the 2nd period as one sentence;
a step of a phrase recognition unit (124) recognizing a comma and characters or term after the comma, and when the characters or term after the comma is one of a conjunction (part of speech), such as “by”, “as”, “then”, “and”, “so”, etc., text after the comma and the text before the comma are each recognized as a phrase; and
a step of a postposition deleting unit (125) deleting a postposition (part of speech, or grammatical particles indicating relationship between a noun, pronoun or other elements in a sentence) characters or term in the copy of the digital text; and
a step of a keyword extracting unit (126) extracting as a keyword or keywords in the text remaining in the copy of the digital text after the deleting step.

4. The method for supporting self-directed learning by student according to claim 3, wherein the step of the worksheet recognizing unit (130) searching sub-content of the digital text copy of the worksheet for the sub-content matching the keyword or keywords extracted by the textbook recognizing unit (120) and recognizing the location of the sub-content comprises:
a step of a paragraph location matching unit recognizing a 1st keyword extracted from a 1st paragraph of the textbook recognized by the paragraph beginning-point recognition unit (121) and the paragraph ending-point recognition unit (122), and searching the digital text copy of the worksheet for a 1st sub-content matching the 1st keyword;
a step of a sentence location matching unit recognizing a 2nd keyword extracted from a 1st sentence of the textbook recognized by the sentence recognition unit (123), and searching the digital text copy of the worksheet for a 2nd sub-content, which is a subsection of the 1st sub-content, matching the 2nd keyword; and
a step of a phrase location matching unit recognizing a 3rd keyword from a 1st phrase of the textbook recognized by the phrase recognition unit (124), and searching the digital text copy of the worksheet for a 3rd sub-content, which is a subsection of the 2nd sub-content, matching the 3rd keyword.

5. The method for supporting self-directed learning by student according to claim 4, wherein the step of the grading unit (140) comparing whether a text within the blank space next to the sub-contents of the worksheet matches another keyword in the textbook, when the location of the sub-content in the worksheet that matches the keyword of the textbook is recognized comprises:
a step of a corrective measure determining unit (141) comparing to see whether a 4th keyword, 5th keyword, and 6th keyword extracted from the first paragraph, first sentence, and first phrase match the text in the blank space next to the 1st sub-content, 2nd sub-content, and 3rd sub-content, respectively; and
a step of a score calculation unit (142) calculating the number of matches between the fourth keyword, the fifth keyword, and the sixth keyword with the text in the blank space.

6. The method for supporting self-directed learning by student according to claim 5, wherein the step of the sub-content reviewing unit (150) deleting the sub-content from the digital text copy of the worksheet and checking whether a text matching the sub-content is input by the student comprise:
a step of a 3rd sub-content reviewing unit (153) deleting the 3rd sub-content from the digital text copy of the worksheet and checking whether the text matching the 3rd sub-content is input by the student, when the 4th keyword, 5th keyword, and 6th keyword all match the text in the blank space;
a step of a 2nd sub-content reviewing unit (152) deleting the 2nd sub-content from the digital text copy of the worksheet and checking whether the text matching the 2nd sub-content is input by the student, when the text matching the 3rd sub-content is input; and
a step of 1st sub-content reviewing unit (151) deleting the 1st sub-content from the digital text copy of the worksheet and checking whether the text matching the 1st sub-content is input by the student, when the text matching the 2nd sub-content is input.
